(19) United States
(12) Patent Application Publication
(10) Pub. No.: US 2011/0263378 A1
(43) Pub. Date: Oct. 27, 2011

(54) Conical- friction-ring transmission and method for infinitely variable transfer of torques by means of a conical-friction-ring transmission

(75) Inventors: Ulrich Rohs, Dueren (DE); Christoph Draeger, Langerwehe/Juengersdorf (DE)

(73) Assignee: Ulrich Rohs, Dueren (DE)

(21) Appl. No.: 13/066,739

(22) Filed: Apr. 22, 2011

(30) Foreign Application Priority Data
Apr. 23, 2010 (DE) 10 2010 018 297.4

(51) Int. Cl. F16H 15/22; F16H 15/42

(52) U.S. Cl. 476/53

(57) ABSTRACT

In order to be able to build conical-friction-ring transmissions more compactly, the invention proposes a conical-friction-ring transmission having a first friction cone, having a second friction cone, having a friction ring, and having at least one other transmission element, in which the first friction cone is mounted to rotate about a first friction-cone bearing axis by means of first friction-cone bearings, and the second friction cone is mounted to rotate about a second friction-cone bearing axis by means of second friction-cone bearings, in which the two friction cones are disposed tensioned relative to one another by means of the friction ring, in which main bearing forces that act radially, with regard to the friction-cone bearing axes, extend in a main bearing plane spanned by the two friction-cone bearing axes, in which the at least one other transmission element precedes or follows the friction cones, and in which coupling moments can be in effect between one of the friction cones and the at least one other transmission element, and the reaction forces produced by the coupling moments are directed counter to the main bearing forces, in the main bearing plane.

The invention relates to a conical-friction-ring transmission having a first friction cone, having a second friction cone, having a friction ring, and having at least one other transmission element, in which the first friction cone is mounted to rotate about a friction-cone bearing axis by means of first friction-cone bearings, and the second friction cone is mounted to rotate about a second friction-cone bearing axis by means of second friction-cone bearings, in which the two friction cones are disposed tensioned relative to one another by means of the friction ring, in which main bearing forces that act radially, with regard to the friction-cone bearing axes, extend in a main bearing plane spanned by the two friction-cone bearing axes, in which the at least one other transmission element precedes or follows the friction cones, and in which coupling moments can be in effect between one of the friction cones and the at least one other transmission element. Furthermore, the invention relates to a method for infinitely variable transfer of torques by means of a conical-friction-ring transmission, in which coupling moments between the friction-cone side and the transmission side are in effect during the transfer of torques between a friction-cone axis and a transmission side, or, vice versa, which moments produce reaction forces in friction-cone bearings.

Conical-friction-ring transmissions of the stated type are well known from the state, of the art, and are excellently suited for adjusting torques in a drive train, in infinitely variable manner, and transferring them between a drive side and a power take-off side of the drive train.

For example, in WO 2006/012892 A2, a friction-ring transmission having two roller bodies that are spaced apart from one another by a gap is described, whereby the roller bodies correspond with one another by way of a friction ring, rotating on axial roller body axes. The friction ring is disposed in an axially freely adjustable adjustment bridge, so as to be displaceable along the gap by an adjustment path. In this connection, the adjustment bridge is mounted by means of a single axial guide device, so that the friction-ring transmission can have a particularly small construction, on the basis of the single guide device.

Another conical-friction-ring transmission is known, for example, from the document GB patent 298676, in which a guide element is guided on a guide axis, parallel to axes of conical friction wheels, which element guides a friction ring along the conical friction wheels. In this way, it is true that infinitely variable adjustment of the translation ratio of the conical-friction-ring transmission can be achieved, but a special drive is necessary for adjustment of the friction ring, which once again makes the conical-friction-ring transmission very complicated in terms of its construction.

Another conical-friction-ring transmission that has a compact construction is described in WO 2005/061928 A2, having at least two transmission elements in the form of conical friction wheels and having at least one connection element in the form of a friction ring. The transmission elements are connected with one another so as to act together, by means of the friction ring. The friction ring is disposed so that it can be displaced relative to the transmission elements, in infinitely variable manner, in terms of its position. In order to be able to adjust the friction ring between the two conical friction wheels, in infinitely variable manner, the friction ring is disposed in a guide device that is mounted so as to pivot about an axis of rotation, the axis direction of which comprises a component that is disposed parallel to a plane spanned by the two axes of the conical friction wheels. The area of use of this conical-friction-ring transmission is found, for example, in a conical-friction-ring transmission in which a torque is supposed to be transferred from an input cone, for example, to an output cone, by way of the rotating friction ring. The guide device used here makes it possible to keep the control of the friction ring very small, so that the conical-friction-ring transmission can be advantageously used even in motor vehicle transmissions.

While it is well possible to adjust torques to be transferred, in infinitely variable manner, by means of the conical-friction-ring transmissions mentioned above, particularly if they have guides or controls of a friction ring required for this purpose, which have a relatively small construction, known conical-friction-ring transmissions still have a rather large construction, because of their relatively large friction cone bearings. This is particularly impedimental in connection with motor vehicle transmissions, since ever greater emphasis is being placed on more compact and more weight-reduced vehicle components, in the automotive sector.

The invention is based on the task of further developing known conical-friction-ring transmissions, in such a manner that they can be built even smaller than has been usual until now.

The task of the invention is accomplished, on the one hand, by a conical-friction-ring transmission having a first friction cone, having a second friction cone, having a friction ring, and having at least one other transmission element, in which the first friction cone is mounted to rotate about a first friction-cone bearing axis by means of first friction-cone bearings, and the second friction cone is mounted to rotate about a second friction-cone bearing axis by means of second friction-cone bearings, in which the two friction cones are disposed tensioned relative to one another by means of the friction ring, in which main bearing forces that act radially, with regard to the friction-cone bearing axes, extend in a main bearing plane spanned by the two friction-cone bearing axes, in which the at least one other transmission element precedes or follows the friction cones, and in which coupling moments can be in effect between one of the friction cones and the at least one other transmission element, and the reaction forces produced by the coupling moments are directed counter to the main bearing forces, in the main bearing plane.

Because of the fact that the reaction forces produced by the coupling moments are directed counter to the main bearing forces of the friction-cone bearings, the friction-cone bearings can advantageously be designed to be significantly smaller than is the case with conventionally designed conical-friction-ring transmissions.

This is particularly advantageous in connection with conical-friction-ring transmissions, since relatively large friction-cone bearings must be used in these transmissions, in order to be able to absorb the tensioning forces that necessarily occur in the case of the tensioned method of construction of the friction cones and of the friction ring. And the higher the torques to be transferred are selected, the more strongly the friction cone and the friction ring must be tensioned relative to one another. Even if work is already performed by means of forces that act counter to one another in other areas of use of mechanical engineering, particularly in order to reduce bearing forces, there is not, as yet, a suitable method of construction with regard to conical-friction-ring transmissions, although particularly great bearing forces have to be managed here.

The “friction-cone bearings” that are used here can be designed, for example, as conical roller bearings, by means of which a fixed bearing side of a friction cone is implemented, in combination with cylinder roller bearings as the loose bearing side. Particularly because of the main force reduction that is achieved, it is also possible to use angular-contact ball bearings, which have a more compact construction, in advantageous manner.

The term “friction-cone bearing axis” is understood to mean the longitudinal axis of a friction cone, about which the friction cone can rotate.

In this connection, the term “transmission element” describes a component of the conical-friction-ring transmission that does not belong to the “friction cone/friction ring” module, and which does not rotate together with a friction cone, on its friction-cone bearing axis.

With regard to the conical-friction-ring transmission described here, the two friction cones and the friction ring form a first module of the conical-friction-ring transmission, which module is capable of functioning on its own, by means of which torques can be transferred from an input side of the conical-friction-ring transmission to an output side of the conical-friction-ring transmission, in infinitely variable manner.

This module can precede and/or follow another transmission element. Such a transmission element can interact, in a coupling region, with a transmission component provided on a friction-cone side. In this way, coupling forces are in effect between the transmission component that is connected, in fixed manner, with a friction cone or with a friction-cone shaft, and the other transmission element, which forces bring about the coupling moments.

In advantageous manner, these coupling moments are present in the conical-friction-ring transmission, in such a manner that they produce reaction forces in the main bearing plane spanned by the friction-cone bearing axes. These reaction forces are directed counter to radially acting main bearing forces in the main bearing plane, so that the radially acting main bearing forces are reduced by the reaction forces, and therefore, in turn, friction-cone bearings having smaller dimensions can be used.

In this connection, the task of the invention is also accomplished by a method for infinitely variable transfer of torques by means of a conical-friction-ring transmission, in which coupling moments between the friction-cone side and the transmission side are in effect during the torque transfer between a friction-cone side and a transmission side, or, vice versa, which moments produce reaction forces in friction-cone bearings, and whereby the method is characterized in that the component of the reaction forces that extends in a main bearing plane of two friction-cone bearing axes acts counter to a main bearing force component that extends in the main bearing plane.

In advantageous manner, main bearing forces are reduced by means of the reaction forces that act in the opposite direction, as has already been explained above, so that friction-cone bearings having a lower bearing load can be used on a conical-friction-ring transmission, and thereby the required construction volume of the conical-friction-ring transmission can also be reduced.

It is particularly advantageous if the direction of rotation of the moments that act on the friction cones is reversed, for example in order to implement a reverse gear on a vehicle. In this connection, it is true that it is accepted that the reaction forces and the main bearing forces add up when the conical-friction-ring transmission is operated to run in the reverse direction. However, this can be ignored, since the conical-friction-ring transmission is only operated in reverse gear for a short time, and existing friction-cone bearings only have to withstand these increased main bearing forces for a short time.

A preferred embodiment variant of the conical-friction-ring transmission provides that the coupling moments are brought about by means of coupling forces in a coupling region that is disposed at a radial distance from the main bearing plane, in such a manner that reaction forces produced by the coupling forces and extending in the main bearing plane can counteract the main bearing forces that extend in the main bearing plane.

If the coupling region is disposed at a radial distance from the main bearing plane, the reaction forces can advantageously be displaced in the main bearing plane, by means of the design.

The “coupling region” is the interface between a transmission component connected with the friction cone in fixed manner and the other transmission element of the conical-friction-ring transmission.

It is understood that the other transmission element can interact not only with a transmission component that is connected with an input friction cone of the conical-friction-ring transmission in fixed manner, but also with a transmission component that is connected with the output friction cone in fixed manner.

Therefore the coupling region can also be provided on the input friction-cone side and/or on the output friction-cone side, on the conical-friction-cone transmission.

Another preferred embodiment variant provides that a transmission component connected with the friction cone in fixed manner is provided on the friction-cone side, which component engages with the at least one other transmission element in a coupling region.

In this connection, the transmission component can be configured in one piece with the friction cone, for example, and furthermore can be represented by the friction cone itself, for example. Alternatively, the transmission component connected with the friction cone in fixed manner can also be disposed on a friction-cone shaft, which rotates about the friction-cone bearing axis with the friction cone. It is understood that in the latter case, the transmission component can be made available directly by the friction cone shaft, or the transmission cone is connected with the friction cone shaft with shape fit, for example. It is essential, in this connection, that a coupling region can be formed on the conical-friction-ring transmission by means of the transmission component that is connected with the friction cone, in fixed manner, which region is disposed at a radial distance from the main bearing plane.

A first alternative embodiment variant provides that gear wheels are provided on the friction-cone side, and that at least one transmission element comprises a chain. In such an exemplary embodiment, the transmission component connected with the friction cone in fixed manner is configured as a gear wheel, whereby this gear wheel is in engagement with a chain that is made available by the at least one transmission element, and that here, coupling forces that bring about the coupling moments are in effect.

Cumulatively or alternatively, gear wheels can be provided on the friction-cone side, and the at least one transmission element also comprises a gear wheel. In this embodiment variant, gear wheels mesh with one another in the coupling region of the conical-friction-ring transmission, and thereby coupling forces that bring about the coupling moments are in effect between the gear wheels.

It is understood that depending on the friction-cone bearing stress relief that is to be achieved, the coupling region can be disposed at almost any radial distance from the main bearing plane. Preferably, the coupling region is disposed at such a radial distance from the main bearing plane that it is disposed perpendicular to the main bearing plane, and the plumb line passes through one of the two friction-cone bearing axes. If a plumb line of the main bearing plane is disposed between the coupling region and one of the two friction-cone bearing axes, the reaction forces produced by means of the coupling moments can be directed counter to the main bearing forces in the main bearing plane, in particularly effective manner.

It is advantageous if an axis of rotation of rotating other transmission elements is disposed to align with the friction-cone bearing axes and next to the main bearing plane spanned by the friction-cone bearing axes.

The conical-friction-ring transmission can be built in very compact manner, particularly if axes of rotation of the other transmission elements run parallel to the friction-cone bearing axes. In this connection, however, attention must be paid to ensure that the coupling regions between the transmission elements and the transmission components connected with the friction cones in fixed manner do not lie in the main bearing plane, because as a result, the coupling moments cannot produce any reaction forces, or only unsuitable reaction forces, in the main bearing plane, which forces can be directed counter to the main bearing forces disposed in the main bearing plane.

Furthermore, it is advantageous if the main bearing plane is oriented in the conical-friction-ring transmission, relative to a transmission underside or a drivable surface, in such a manner that an angle of more than 20° is disposed between the main bearing plane and the transmission underside and/or the drivable plane. By means of the selection of such an angle setting, it is also ensured that the reaction forces produced by coupling forces and the existing main bearing forces counteract one another in advantageous manner, and that they can be reduced to a sufficient extent in this connection.

Further advantages, goals, and properties of the present invention will be explained using the following description of the attached drawing, in which conical-friction-ring transmissions and components of them are presented as examples.

The drawing shows

FIG. 1 schematically, a longitudinal section of a transmission having two transmission stages, in which the first transmission stage comprises a conical-friction-ring transmission having an input friction cone, an output friction cone, and a friction ring disposed between them,

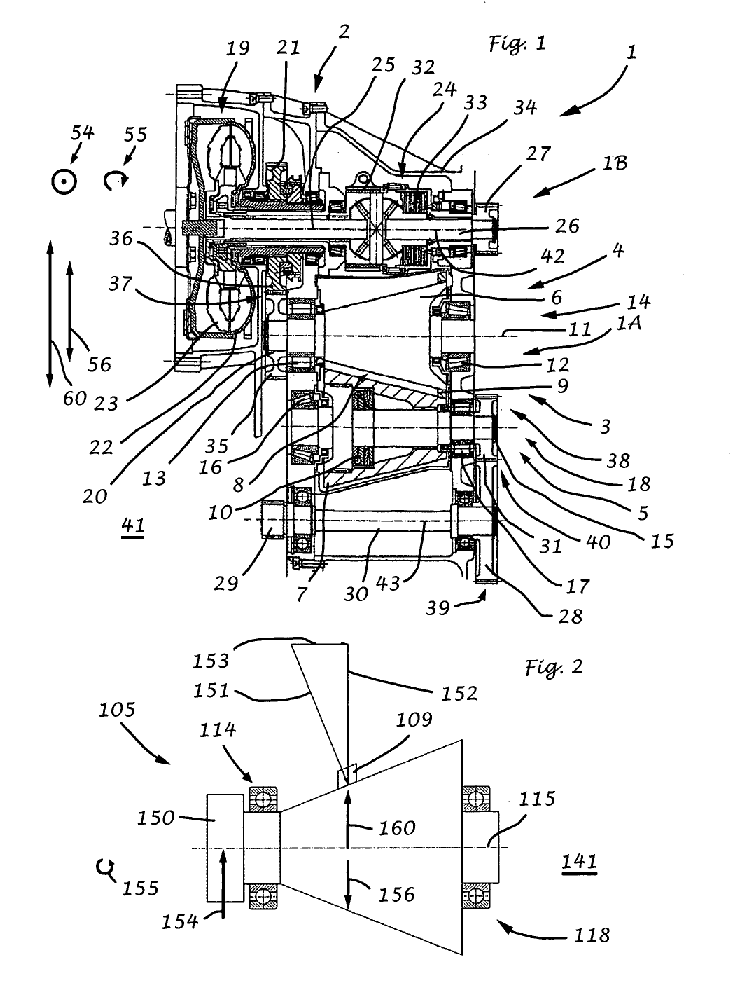

FIG. 2 schematically, a view of an output friction cone, with friction-ring forces drawn in,

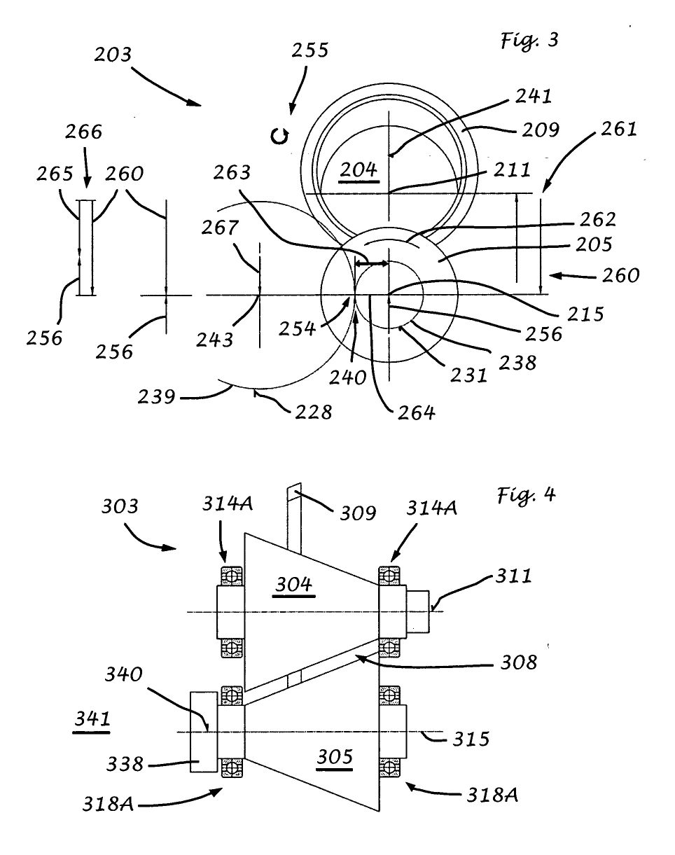

FIG. 3 schematically, an axial view of a conical-friction-ring transmission, having a gear wheel disposed on the friction-cone side, and a transmission element that comprises a gear wheel and meshes with the former,

FIG. 4 schematically, a radial view of a conical-friction-ring transmission, similar to the conical-friction-ring transmission from FIG. 3,

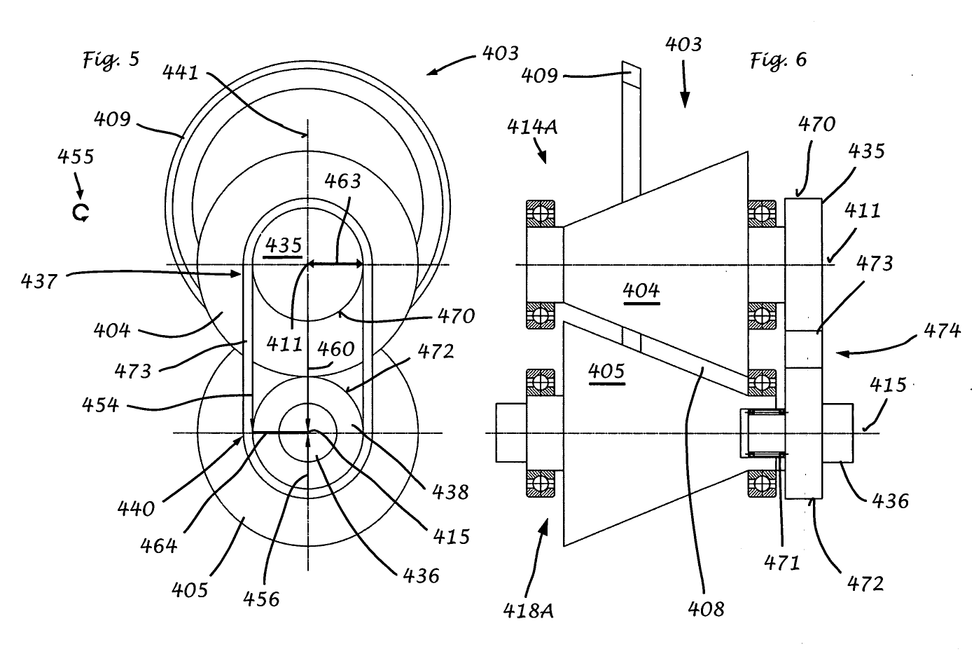

FIG. 5 schematically, an axial view of another conical-friction-ring transmission having a gear wheel disposed on the friction-cone side and a transmission element that comprises a chain,

FIG. 6 schematically, a radial view of the other conical-friction-ring transmission from FIG. 5, and

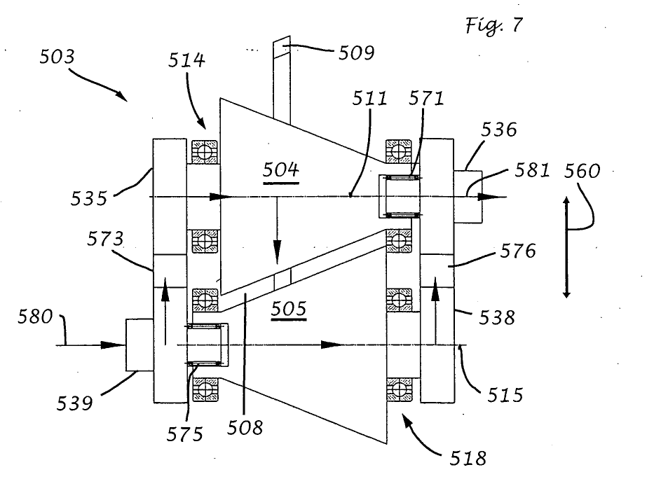

FIG. 7 schematically, a view of an alternative conical friction ring having two chains.

The transmission 1 shown in FIG. 1 essentially comprises two transmission stages 1A, 1B, which can optionally be shifted in a drive train, by way of a synchronous manual transmission 2. In this connection, the first transmission stage 1A has a conical-friction-ring transmission 3 having two friction cones 4, 5 disposed to rotate in opposite directions, whereby the first friction cone 4 represents an input friction cone 6, and the second friction cone 5 represents an output friction cone 7 of the conical-friction-ring transmission 3. The two friction cones 4, 5 are disposed in such a manner that a gap 8 remains between the friction cones 4, 5, in which gap a friction ring 9 runs, surrounding the friction cone 4.

In order for this conical-friction-ring transmission 3 to be able to transfer particularly great torques, the friction cone 5 in this exemplary embodiment additionally comprises a press-down device 10, not explained in any greater detail here, which device tensions the two friction cones 4 and 5, by applying a variable press-down force by way of the friction ring 9.

The first friction cone 4 rotates about a first friction-cone bearing axis 11 and is mounted with the conical roller bearing 12, on the one hand, and with the cylindrical roller bearing 13, on the other hand, whereby the conical roller bearing 12 and the cylindrical roller bearing 13 form first friction-cone bearings 14 of the conical-friction-ring transmission 3.

The second friction cone 5 rotates about a second friction-cone bearing axis 15 and is mounted with another conical roller bearing 16, on the one hand, and with another cylindrical roller bearing 17 of the conical-friction-ring transmission 3, on the other hand, whereby the other conical roller bearing 16 and the other cylindrical roller bearing 17 form second friction-cone bearings 18 of the conical-friction-ring transmission 3.

The exemplary embodiment of the transmission 1 as shown furthermore comprises a start-up clutch, which is implemented as a Trilok converter 19, on the drive side, with regard to the conical-friction-ring transmission 3, which is adjustable in infinitely variable manner.

The transmission stage 1A that comprises the conical-friction-ring transmission 3 can be directly connected with the pump wheel 22 of the Trilok converter 19, by way of the manual transmission 2 or a drive gear wheel 20 and a synchronized gear wheel 21, while start-up can take place by way of the turbine wheel 23 of the Trilok converter 19 and by way of a differential transmission part 24. The latter differential transmission part 24 is rigidly connected with the turbine wheel 23 with the one differential side 25, while the second differential side 26 is used as a power take-off of the second transmission stage 1B and is connected with a main power take-off shaft gear wheel 28 of a main power take-off shaft 30 of the transmission 1, comprising a power take-off pinion 29, by way of a differential transmission gear wheel 27, whereby on the other hand, the main power take-off shaft gear wheel 28 meshes with a power take-off gear wheel 31 of the conical-friction-ring transmission part 1. The power take-off pinion 29 can mesh with a main differential (not shown here) of a motor vehicle (also not shown here), for example.

The differential transmission part 24 furthermore comprises two friction clutches 30, 31, which can optionally fix the main input of the differential transmission part 24 in place on the housing 34 or on the second differential side 26. In this way, as is directly evident, the direction of rotation of the power take-off can be changed, and a forward and a reverse gear can easily be implemented in this manner.

When the friction clutches 32, 33 are open, the differential transmission part 24 as well as the turbine wheel 23 rotate along freely, so that the conical-friction-ring transmission 3 can be utilized despite the coupling of the power take-offs. This arrangement has the advantage that the advantages of the Trilok converter 19 can be utilized for start-up or in reverse gear. Furthermore, forward and reverse gear are implemented in extremely compact manner by means of the differential transmission part 24. On the other hand, the disadvantage of the Trilok converter 19, of bringing about great power losses as well as excessive torque due to slippage in normal operation, can be avoided by means of the manual transmission 2, because the turbine wheel 23 is short-circuited by means of the manual transmission 2, and the drive of the first transmission stage 1A with its conical-friction-ring transmission 3 takes place directly by way of the pump wheel 22. The coupling of the two transmission stages 1A and 1B on the power take-off side furthermore makes it possible to adjust the conical-friction-ring transmission 3, with regard to its translation, before a shifting process between these two transmission stages 1A and 1B takes place, in such a manner that the two transmission stages 1A and 1B are almost synchronized also on the input side. The remaining synchronization can be undertaken by the manual transmission 2 itself, whereby the Trilok converter 19 can also have a supporting effect.

The drive gear wheel 20 forms a first transmission component 35 that is connected, in fixed manner, with the first friction cone 4, and rotates about the first friction-cone bearing axis 11, together with the friction cone 4, in this connection.

In this connection, the synchronized gear wheel 21 forms a first transmission element 36 that is connected to act with the drive gear wheel 20 in a first coupling region 37 of the conical-friction-ring transmission 3.

The power take-off gear wheel 31 forms another transmission component 38, which is connected, in fixed manner, with the second friction cone 5 and rotates about the friction-cone bearing axis 15 with the latter. In this connection, the power take-off gear wheel 31 interacts with the main power take-off shaft gear wheel 28, which represents another transmission element 39 of the transmission 1, so that the main power take-off shaft gear wheel 28 and the power take-off gear wheel 31 interact with one another in another coupling region 40 of the conical-friction-ring transmission 3.

The two friction-cone bearing axes 11 and 15 span a main bearing plane 41 that lies in the plane of the paper in this exemplary embodiment.

Both the differential transmission axis of rotation 42 and the main power take-off shaft axis of rotation 43 ideally lie at a radial distance from this main bearing plane 41, so that the two coupling regions 37 and 40 can also be disposed at a radial distance from the main bearing plane 41.

Because the coupling regions 37, 40 can be disposed outside of the main bearing plane 41, coupling moments 55 (drawn in only as examples here) brought about by means of coupling forces 54 (drawn in only as examples here) can act between the first transmission component 35 and the first transmission element 36 as well as between the other transmission component 38 and the other transmission element 39. These coupling moments 55 then produce reaction forces 56 (drawn in only as examples here), which can act counter to the main bearing forces 60 (drawn in only as examples here) that extend in the main bearing plane 41. The location of the coupling moments 55 is secondary, in this connection, as long as suitable reaction forces 56 can be produced with them, which can act counter to the main bearing forces 60 in suitable manner.

While the friction-cone bearing axes 11, 15 and the differential transmission axis of rotation 42 and the main power take-off shaft axis of rotation 43 are ideally disposed in different planes, they run aligned with one another, since they are disposed parallel to one another, at least in this exemplary embodiment.

In particular, the forces and torques described above and further below are not drawn in as examples, since their size, location, and direction of action can occur or change in accordance with the design conditions, in each instance, particularly if the conical-friction-ring transmission is operated in reverse, in order to implement a reverse gear on a vehicle transmission. Also, the type of gearing of the transmission components that interact with one another can particularly influence the direction of the forces produced and/or the moments brought about.

The output friction cone 105, of a module, not shown in any greater detail here, of a conical-friction-ring transmission, is mounted so as to rotate about a friction-cone bearing axis 115, in a first friction-cone bearing 114 and in a second friction cone bearing 118, which are configured as angular-contact ball bearings in this exemplary embodiment. A gear wheel 150 rotates together with the output friction cone 105 on the friction-cone side, which gear is connected, in fixed manner, with the output friction cone 105.

The output friction cone 105 stands in contact with a friction ring 109, and is connected to act together with an input friction cone, not shown further here, by means of the friction ring 109. Friction forces 151 having a radial friction force component 152 and an axial friction force component 153 are in effect between the output friction cone 105 and the friction ring 109.

The friction forces 151 find their origin in that the output friction cone 105, the friction ring 109, and the input friction cone not shown in any greater detail here are disposed so as to be tensioned with one another. In this connection, the friction forces 151 cause main bearing forces 160 in the friction-cone bearings 114, 118, which must be absorbed by the friction-cone bearings 114, 118.

Coupling forces 154 (drawn in only as examples here) occur at the gear wheel 150, which interacts with another transmission element, not shown in any greater detail here, and bring about coupling moments 155 (drawn in only as examples here).

The coupling moments 155 in turn produce reaction forces 156 (drawn in only as examples here), which counteract the friction-force component 152 that acts radially in a main bearing plane 141, and thus reduce the main bearing forces 160 (drawn in only as examples here) of the friction-cone bearings 114, 118. In advantageous manner, the friction-cone bearings 114, 118 can be designed to be smaller by means of this force reduction, and therefore construction space is saved, on the one hand, and weight is saved, on the other hand.

The conical-friction-cone transmission 203 shown in FIG. 3 has a first friction cone 204, a second friction cone 205, and a friction ring 209 disposed between them. In this representation, the prevailing force and torque conditions are drawn in schematically, whereby forces can also be shown and numbered multiple times, in order to show these in a force schematic, in terms of their effect.

The first friction cone 204 rotates about a first friction-cone bearing axis 211, whereby the second friction cone 205 rotates in the opposite direction, about a second friction-cone bearing axis 215. A transmission component 238 connected in fixed manner with the second friction cone 205 rotates with the second friction cone 205, which component is conceived as a power take-off gear wheel 231. The two friction-cone bearing axes 211, 215 span a main bearing plane 241 in which main bearing forces 260 act as a main bearing force pair 261.

The power take-off gear wheel 231 is in engagement, in a coupling region 240, with another transmission element 239, which is designed as a main power take-off shaft gear wheel 228. The main power take-off shaft gear wheel 228 is mounted to rotate about a main power take-off shaft axis of rotation 243.

Coupling forces 254 occur in the coupling region 240, which forces are applied to the second friction cone 205 between the power take-off gear wheel 231 on the friction-cone side and the main power take-off shaft gear wheel 228, on the transmission side, on the basis of an output torque 262.

The coupling region 240 is disposed at a distance 263 from the main bearing plane 241, in such a manner that a plumb line 264 is dropped between the coupling region 240 and the friction-cone bearing axis 215.

Here again, the coupling forces 254 bring about coupling moments 255, which in turn produce rotation forces 256 due to the distance 263 between the coupling region 240 and the main bearing plane 241, which forces are directed counter to the main bearing forces 242 in the main bearing plane 241, so that the main bearing forces 242 are reduced, by the amount of the reaction forces 256, to the resulting forces 265, as is evident from the forces schematic 266. Main power take-off gear wheel bearing forces that can be ignored in the present case are applied with regard to the main power take-off shaft gear wheel 228, in this connection.

The conical-friction-ring transmission 303 shown in a side view in FIG. 4 has a similar structure as the conical-friction-ring transmission 203 from FIG. 3 described above.

The conical-friction-ring transmission 303 has a first friction cone 304 and a second friction cone 305, which stand in functional contact with a friction ring 309, spaced apart by a gap 308.

In this connection, the first friction cone 304 rotates about a first friction-cone bearing axis 311, and the second friction cone 305 rotates about a second friction-cone bearing axis 315. The two friction cones 304, 305 are mounted with first angular-contact ball bearings 314A and second angular-contact ball bearings 318A.

The second friction cone 305 is connected, in fixed manner, with another transmission component 338, and the other transmission component 338 rotates about the second friction-cone bearing axis 315 together with the second friction cone 305.

The transmission component 338 makes available a coupling region 340 that is placed at a radial distance from a main bearing plane 341.

In order to avoid repetition, reference is made, with regard to the method of action of the forces and torques that are applied here, to the explanation of the preceding exemplary embodiments of FIGS. 1 to 3.

The conical-friction-ring transmission 403 shown in FIGS. 5 and 6 comprises a first friction cone 404 and a second friction cone 405, between which a friction ring 409 runs in a gap 408. The first friction cone 404 is mounted in first angular-contact ball bearing 414A, so that it can securely rotate about a first friction-cone bearing axis 411. Analogously, the second friction cone 405 is mounted in second friction-cone bearing 418, and rotates about a second friction-cone bearing axis 415.

A first transmission component 435 is attached to the first friction cone 404; in this exemplary embodiment, this component is configured as a first friction-cone gear wheel 470.

A transmission element 436 is mounted to rotate on the second friction cone 405, by means of a needle roller bearing 471, on the second friction-cone bearing axis 415 of the second friction cone 405. The first transmission element 436 comprises a transmission element gear wheel 472. In this connection, the first friction-cone gear wheel 470 and the transmission element gear wheel 472 are connected with one another by means of a gear wheel chain 473. The gear chain 473 is an additional transmission element 474 of the conical-friction-ring transmission 403.

The first friction-cone gear wheel 470 and the gear wheel chain 473 interact in first coupling regions 437 (numbered only as examples here), and the transmission element gear wheel 472 interacts with the gear wheel chain 473 in second coupling regions 440 (numbered only as examples here), as another transmission component 438 on the friction-cone side.

The first and second coupling regions 437, 440 are disposed spaced apart from one another at a distance 463 (drawn in only as an example), from a main bearing plane 441 that is spanned by the two friction-cone bearing axes 411 and 415. The first and second coupling regions 437, 440 are disposed relative to the friction-cone bearing axes 411 and 415, in each instance, in such a way that the distance 463 between them forms a plumb line 464 (drawn in only as an example), which runs through the friction-cone bearing axis 411, 415, in each instance, and the corresponding coupling region 437, 440.

Because the two friction cones 404, 405 are tensioned with one another by way of the friction ring 409, main bearing forces 460 that extend in the main bearing plane 441 act on the angular-contact ball bearings 414A, 418A.

Coupling forces 454 are in effect in the coupling regions 437, 440, as a result of the tensile force of the gear wheel chain 473, and these forces bring about coupling moments 455 that produce reaction forces 456 because of the radially removed location of the coupling regions 437, 440 relative to the main bearing plane 441, and these forces can act counter to the main bearing forces 460, depending on the tension direction of the tensile force in the main bearing plane 441. In advantageous manner, a main bearing force reduction can already be achieved by means of the gear wheel chain 473, without transmission components 435, 438 that rotate with the friction cones 404, 405 necessarily having to be in engagement, for example with a synchronized gear wheel (see FIG. 1) or with a main power take-off shaft gear wheel (see FIG. 1) outside of the main bearing axis 441.

The conical-friction-ring transmission 503 shown in FIG. 7 comprises friction cones 504, 505, which are disposed spaced apart from one another by a gap 508, and which stand in functional contact with one another by means of a friction ring 509. In this connection, the two friction cones 504, 505 are tensioned with one another by means of the friction ring 509, in known manner, so that correspondingly great main bearing forces 560 are in effect in the friction-cone bearings 514, 518, in each instance.

The first friction cone 504 comprises a first transmission component 535, which is connected, in fixed manner, with the first friction cone 504. Another transmission component 538 is provided on the second friction cone 505, and connected, in fixed manner, with the second friction cone 505.

Furthermore, a first transmission element 536 is mounted on the first friction cone 504 by means of a first needle roller bearing 571. The first friction cone 504 and the first transmission element 536 are mounted on a first friction-cone bearing axis 511, so as to rotate separately, by means of the needle roller bearing 571. Analogously, another transmission element 539 is mounted on the second friction-cone bearing axis 515, with a second needle roller bearing 575. The second friction cone 505 can also rotate about the second friction-cone bearing axis 515.

Similar to the conical-friction-ring transmissions 403 from FIGS. 5 and 6 explained above, the first transmission component 535 is connected with the other transmission element 539 by means of a first gear wheel chain 573 in the case of this conical-friction-ring transmission 503, as well. Furthermore, however, the other transmission component 538 and the first transmission element 536 are connected with a second gear wheel chain 576.

The transmission elements 536, 539 and the transmission components 535 and 538 stand in connection with the gear wheel chains 573, 576 in a similar manner, by way of coupling regions, not shown here, as was described with regard to the conical-friction-ring transmission 403 from FIGS. 5 and 6, and as a result, a main bearing force reduction can be achieved by means of the gear wheel chains 573 and 576, without the transmission components 535, 536, 538, and 539, which rotate with the friction cones 404, 405, necessarily having to be in engagement with a first transmission element (see, for example, FIG. 1) or with another transmission element (see also, for example, FIG. 1), outside of the main bearing axis 441. For the sake of a clearer representation and in order to avoid repetition, in this exemplary embodiment there will not be any further explanation of the forces and torques that are in effect here.

However, a possible and preferred power flow is still drawn in, which is introduced starting with an input power 580, going by way of the first gear wheel chain 573 from the transmission element 539 to the first transmission component 535, and from there further into the first friction cone 504. From there, the power flow that was introduced at the transmission element 539 continues by way of the friction ring 509, and the input power 580 is transferred further to the second friction cone 505, from where the power flow is transferred to the first transmission element 536 by way of the other transmission component 538 and by means of the second gear wheel chain 576, and then can be tapped at this transmission element 536, as a stepped-up or stepped-down output power 581.

### REFERENCE SYMBOL LIST

1 transmission
1A first transmission stage
1B second transmission stage
2 manual transmission
3 conical-friction-ring transmission
4 first friction cone
5 second friction cone
6 input friction cone
7 output friction cone
8 gap
9 friction ring
10 press-down device
11 first friction-cone bearing axis
12 conical roller bearing
13 cylindrical roller bearing
14 first friction-cone bearing
15 second friction-cone bearing axis
16 other conical roller bearing
17 other cylindrical roller bearing
18 second friction-cone bearing
19 Trilok converter
20 drive gear wheel
21 synchronized gear wheel
22 pump wheel
23 turbine wheel
24 differential transmission part
25 first differential side
26 second differential side
27 differential transmission gear wheel
28 main power take-off shaft gear wheel
29 power take-off pinion
30 main power take-off shaft
31 power take-off gear wheel
32 first friction clutch
33 second friction clutch
34 housing
35 first transmission component
36 first transmission element
37 first coupling region
38 other transmission component
39 other transmission element
40 other coupling region
41 main bearing plane
42 differential transmission axis of rotation
43 main power take-off shaft axis of rotation
54 coupling forces
55 coupling moments
56 reaction forces
60 main bearing forces
105 conical-friction-ring transmission
109 friction ring
114 first friction-cone bearing
115 second friction-cone bearing axis
118 second friction-cone bearing
141 main bearing plane
150 gear wheel
151 friction forces
152 radially acting friction force component
153 axially acting friction force component
154 coupling forces
155 coupling moments
156 reaction forces
160 main bearing forces
203 conical-friction-ring transmission
204 first friction cone
205 second friction cone
209 friction ring
211 first friction-cone bearing axis
215 second friction-cone bearing axis
228 main power take-off shaft gear wheel
231 power take-off gear wheel
238 other transmission component
239 other transmission element
240 coupling region
241 main bearing plane
243 main power take-off shaft axis of rotation
254 coupling forces
255 coupling moments
256 reaction forces
260 main bearing forces
261 main bearing forces pair
262 output torque
263 distance
264 plumb line
265 resulting forces
266 force schematic
267 main power take-off shaft gear wheel bearing forces
303 conical-friction-ring transmission
304 first friction cone
305 second friction cone
308 gap
309 friction ring
311 first friction-cone bearing axis
314A first angular-contact ball bearing
315 second friction-cone bearing axis
318A other angular-contact ball bearing
338 other transmission component
340 coupling region
341 main bearing plane
403 conical-friction-ring transmission
404 first friction cone
405 second friction cone
408 gap
409 friction ring
411 first friction-cone bearing axis
414A first angular-contact ball bearing
415 second friction-cone bearing axis
418A second angular-contact ball bearing
435 first transmission component
436 first transmission element
437 first coupling region
438 other transmission component
440 other coupling region
441 main bearing plane
455 coupling moments
456 reaction forces
460 main bearing forces
463 distance
464 plumb line
470 first friction-cone gear wheel
471 needle roller bearing
472 transmission element gear wheel
473 gear wheel chain
474 additional transmission element
503 conical-friction-ring transmission
504 first friction cone
505 second friction cone
508 gap
509 friction ring
511 first friction-cone bearing axis
514 first friction-cone bearing
515 second friction-cone bearing axis
518 second friction cone bearing
535 first transmission element component
536 first transmission element
538 other transmission component
539 other transmission element
560 main bearing forces
571 first needle roller bearing
573 first gear wheel chain
575 second needle roller bearing
576 second gear wheel chain
580 input power
581 output power

1. Conical-friction-ring transmission (3) having a first friction cone (4), having a second friction cone (5), having a friction ring (9), and having at least one other transmission element (36, 39), in which the first friction cone (4) is mounted to rotate about a first friction-cone bearing axis (11) by means of first friction-cone bearings (14), and the second friction cone (5) is mounted to rotate about a second friction-cone bearing axis (15) by means of second friction-cone bearings (18), in which the two friction cones (4, 5) are disposed tensioned relative to one another by means of the friction ring (9), in which main bearing forces (60) that act radially, with regard to the friction-cone bearing axes (11, 15), extend in a main bearing plane (41) spanned by the two friction-cone bearing axes (11, 15), in which the at least one other transmission element (36, 39) precedes or follows the friction cones (4, 5), and in which coupling moments can be in effect between one of the friction cones (4, 5) and the at least one other transmission element (36, 39), wherein the reaction forces (56) produced by the coupling moments (55) are directed counter to the main bearing forces (60), in the main bearing plane (41).

2. Conical-friction-ring transmission (3) according to claim 1, wherein the coupling moments (55) are brought about by coupling forces (54) in a coupling region (37, 40), which is disposed at a radial distance from the main bearing plane (41), in such a manner that reaction forces (56) produced by the coupling forces (54), which extend in the main bearing plane (41), can act counter to the main bearing forces (60) that extend in the main bearing plane (41).

3. Conical-friction-ring transmission (3) according to claim 1, wherein a transmission component (35, 38) that is connected, in fixed manner, with the friction cone (4, 5), is provided on the friction-cone side, on the friction-cone bearing axes (11, 15), which component is in engagement with the at least one other transmission element (36, 39) in a coupling region (37, 40).

4. Conical-friction-ring transmission (3) according to claim 1, wherein gear wheels (470) are provided on the friction-cone side, and that at least one transmission element comprises a chain (473).

5. Conical-friction-ring transmission (3) according to claim 1, wherein gear wheels (20) are provided on the friction-cone side, and that at least one transmission element (36) comprises a gear wheel (21).

6. Conical-friction-ring transmission (3) according to claim 2, wherein a plumb line (264) of the main bearing plane (241) is disposed between the coupling region (240) and one (215) of the two friction-cone bearing axes (211, 215).

7. Conical-friction-ring transmission (3) according to claim 1, wherein an axis of rotation (42) of rotating other transmission elements (36) is disposed aligned with the friction-cone bearing axes (11, 15) and next to the main bearing plane (41) spanned by the friction-cone bearing axes (11, 15).

8. Conical-friction-ring transmission (3) according to claim 1, wherein the main bearing plane (41) is oriented in the conical-friction-ring transmission (3), relative to a transmission underside or a road surface, in such a manner that an angle of more than 20° is disposed between the main bearing plane (41) and the transmission underside and/or the road plane.

9. Method for infinitely variable transfer of torques by means of a conical-friction-ring transmission (3), in which coupling moments (55) between the friction-cone side and the transmission side are in effect during the torque transfer between a friction-cone side and a transmission side, or, vice versa, which moments produce reaction forces (56) in friction-cone bearings (14, 18), wherein the component of the reaction forces (56) that extends in a main bearing plane (41) of two friction-cone bearing axes (14, 18) acts counter to a main bearing force component (60) that extends in the main bearing plane (41).

10. Method according to claim 9, wherein the direction of rotation of the friction cones (4, 5) is reversed in order to implement a reverse gear in a vehicle.
